(19) United States
(12) Patent Application Publication
(10) Pub. No.: US 2008/0135375 A1
(43) Pub. Date: Jun. 12, 2008

(54) CONVEYOR APPARATUS

(76) Inventor: Michael Travis Pettijohn, Carmel, IN (US)

Correspondence Address: BARNES & THORNBURG LLP, 11 SOUTH MERIDIAN, INDIANAPOLIS, IN, 46204, US

(21) Appl. No.: 11/952,237

(22) Filed: Dec. 7, 2007

Related U.S. Application Data
(60) Provisional application No. 60/873,767, filed on Dec. 8, 2006.

(51) Int. Cl. B65G 21/10

(52) U.S. Cl. 198/320

(57) ABSTRACT

An apparatus configured to be coupled to a vehicle comprises a conveyor and a first joint coupled to the conveyor. The first joint defines a first axis about which the conveyor is configured to pivot between a stowed orientation and a use orientation. The apparatus further includes a second joint coupled to the conveyor. The second joint defines a second axis about which the conveyor is configured to pivot from side to side. The apparatus further includes a third joint coupled to the conveyor and configured to be coupled to the vehicle. The third joint defines a third axis about which the conveyor is able to pivot.

### CROSS-REFERENCE TO RELATED APPLICATIONS

This application claims the benefit of the Dec. 8, 2006 filing date of my U.S. Ser. No. 60/873,767. The entire disclosure of U.S. Ser. No. 60/873,767 is hereby incorporated herein by reference.

### FIELD OF THE INVENTION

This invention relates to a conveyor and, in particular, to a conveyor adapted to be mounted to the rear of a truck or other vehicle to dispense material therefrom.

### BACKGROUND OF THE INVENTION

Various conveyor systems adapted for attachment to the rear of a truck or other vehicle in order to dispense material from the vehicle are known. There are, for example, the conveyor systems illustrated and described in U.S. Pat. Nos. 5,044,867; 5,193,971; and 5,443,351, and references cited therein. The disclosures of these references are hereby incorporated herein by reference. This listing is not intended to be a representation that a complete search of all relevant art has been made, or that no more pertinent art than that listed exists, or that the listed art is material to patentability. Nor should any such representation be inferred.

### DISCLOSURE OF THE INVENTION

According to an aspect of the invention, an apparatus is configured to be coupled to a vehicle. The apparatus comprises a conveyor including a conveyor belt, and a first joint coupled to the conveyor. The first joint defines a first axis about which the conveyor is configured to pivot between a stowed orientation and a use orientation. The apparatus further includes a second joint coupled to the conveyor. The second joint defines a second axis about which the conveyor is configured to pivot from side to side. The apparatus further includes a third joint coupled to the conveyor and configured to be coupled to the vehicle. The third joint defines a third axis about which the conveyor is able to pivot.

Illustratively according to this aspect of the invention, the second joint includes a turret assembly having a turret hub coupled to the conveyor for pivoting movement about the first axis with the conveyor, a turret holder positioned around the turret hub and configured to be coupled to the vehicle, and a drive mechanism coupled to the conveyor and the turret holder.

Illustratively according to this aspect of the invention, the turret hub is generally cylindrical and the second axis extends through a center of the turret hub.

Illustratively according to this aspect of the invention, the drive mechanism includes a first hydraulic cylinder having a first end coupled to the conveyor and a second end pivotally coupled to the turret holder.

Illustratively according to this aspect of the invention, the drive mechanism includes a second hydraulic cylinder having a first end coupled to the conveyor and a second end pivotally coupled to the turret holder.

Illustratively according to this aspect of the invention, the drive mechanism includes first and second hydraulic cylinders and a cable having a first end coupled to the first hydraulic cylinder, a second end coupled to the second hydraulic cylinder, and a middle portion between the first and second ends extending around the turret holder.

Illustratively according to this aspect of the invention, the drive mechanism includes first and second hydraulic cylinders and a chain having a first end coupled to the first hydraulic cylinder, a second end coupled to the second hydraulic cylinder, and a middle portion between the first and second ends extending around the turret holder.

Illustratively according to this aspect of the invention, the turret holder includes a sprocket. The chain engages the sprocket.

Illustratively according to this aspect of the invention, the drive mechanism includes a motor coupled to the conveyor and a chain coupled to the motor and the turret holder.

Illustratively according to this aspect of the invention, the turret holder includes a sprocket. The chain engages the sprocket.

Illustratively according to this aspect of the invention, the third joint includes a hub configured to be coupled to the vehicle, a ring positioned around the hub for movement about the third axis relative to the hub, and a bracket assembly coupled to the ring and the conveyor.

Illustratively according to this aspect of the invention, the third axis is defined through the center of the hub.

Illustratively according to this aspect of the invention, a portion of the third joint is received within a portion of the second joint when the conveyor is in the stowed orientation.

Illustratively according to this aspect of the invention, the second axis and the third axis intersect each other when the conveyor is in a use orientation.

Illustratively according to this aspect of the invention, the first joint includes a hinge pin coupled to the second joint.

Further illustratively according to this aspect of the invention, the apparatus comprises a winch assembly coupled to a distal end of the conveyor.

Illustratively according to this aspect of the invention, the winch assembly includes a spool coupled to the conveyor, a motor coupled to the spool to rotate the spool in first and second directions, and a cable coupled to the spool and configured to be coupled to the vehicle.

Illustratively according to this aspect of the invention, the conveyor further includes a first pulley at a distal end of the conveyor and a second pulley at a proximal end of the conveyor. The conveyor belt is trained around the first and second pulleys.

Illustratively according to this aspect of the invention, the conveyor further includes a hydraulic motor coupled to the first pulley to rotate the first pulley.

Illustratively according to this aspect of the invention, the conveyor further includes an engine/transmission coupled to the first pulley to rotate the first pulley.

Illustratively according to this aspect of the invention, the conveyor defines a length between a proximal end of the conveyor and a distal end of the conveyor. The length of the conveyor remains relatively unchanged as the conveyor is moved between a use orientation and a non-use orientation.

According to another aspect of the invention, an apparatus is configured to be coupled to a vehicle. The apparatus comprises a conveyor configured to move between a non-use orientation generally adjacent the vehicle and a use orientation not generally adjacent the vehicle.

Further illustratively according to this aspect of the invention, the apparatus comprises a pivot joint coupled to the conveyor and configured to be coupled to the vehicle. The conveyor is configured to pivot about an axis of the pivot joint.

Illustratively according to this aspect of the invention, the conveyor includes a proximal end configured to be coupled to the vehicle and a distal end extending away from the vehicle when the conveyor is in the use orientation.

Illustratively according to this aspect of the invention, the conveyor includes first and second spaced apart sides, and a conveyor belt forming a continuous loop between a proximal end of the conveyor and a distal end of the conveyor and between the first and second spaced apart sides.

Illustratively according to this aspect of the invention, the conveyor further includes a first pulley at the proximal end and a second pulley at the distal end. The conveyor belt is trained around the first and second pulleys.

Illustratively according to this aspect of the invention, the conveyor defines a length between a proximal end of the conveyor and a distal end of the conveyor. The length of the conveyor remains relatively unchanged as the conveyor is moved between the use and non-use orientations.

According to another aspect of the invention, an apparatus configured to be coupled to a vehicle comprises a conveyor movable between a use position and a non-use position. The conveyor includes first and second unarticulated sides, a proximal end configured to be coupled to the vehicle and a distal end. A first pulley is coupled to the distal end of the conveyor. A second pulley is coupled to the proximal end of the conveyor. A conveyor belt is trained around the first and second pulleys. A winch is coupled to the distal end of the conveyor. The winch includes a motorized spool. A cable is wound on the spool and configured to be coupled to the vehicle. The proximal end of the conveyor is coupled to the vehicle at a joint. The joint defines an axis generally perpendicular to a surface of the vehicle from which the joint is mounted. The conveyor is configured to pivot about the axis.

### BRIEF DESCRIPTION OF THE DRAWINGS

The invention may best be understood by referring to the following detailed description and accompanying drawings which illustrate the invention. In the drawings:

FIG. 1 illustrates a fragmentary perspective view of the rear portion of a vehicle with a conveyor apparatus coupled to the tailgate of the vehicle, the conveyor apparatus being illustrated in a stowed orientation;

FIG. 2 illustrates a fragmentary perspective view of the apparatus illustrated in FIG. 1 in a use orientation;

FIG. 3 illustrates an enlarged fragmentary perspective view of certain details of the apparatus illustrated in FIGS. 1-2;

FIG. 4 illustrates a fragmentary and partly sectional rear elevational view of certain details of the apparatus illustrated in FIGS. 1-3;

FIG. 5 illustrates is a fragmentary top plan view of certain details of the apparatus illustrated in FIGS. 1-4;

FIG. 6 illustrates a fragmentary side elevational view of certain details of the apparatus illustrated in FIGS. 1-5;

FIG. 7 illustrates a fragmentary top plan view of another embodiment of the apparatus illustrated in FIGS. 1-6;

FIG. 8 illustrates a fragmentary top plan view of another embodiment of the apparatus illustrated in FIGS. 1-6 and 7;

FIG. 9 illustrates a fragmentary top plan view of another embodiment of the apparatus illustrated in FIGS. 1-6, 7 and 8;

FIG. 10 illustrates a fragmentary top plan view of another embodiment of the apparatus illustrated in FIGS. 1-6, 7, 8 and 9; and,

FIG. 11 illustrates a fragmentary top plan view of another embodiment of the apparatus illustrated in FIGS. 1-6

### DETAILED DESCRIPTIONS OF ILLUSTRATIVE EMBODIMENTS

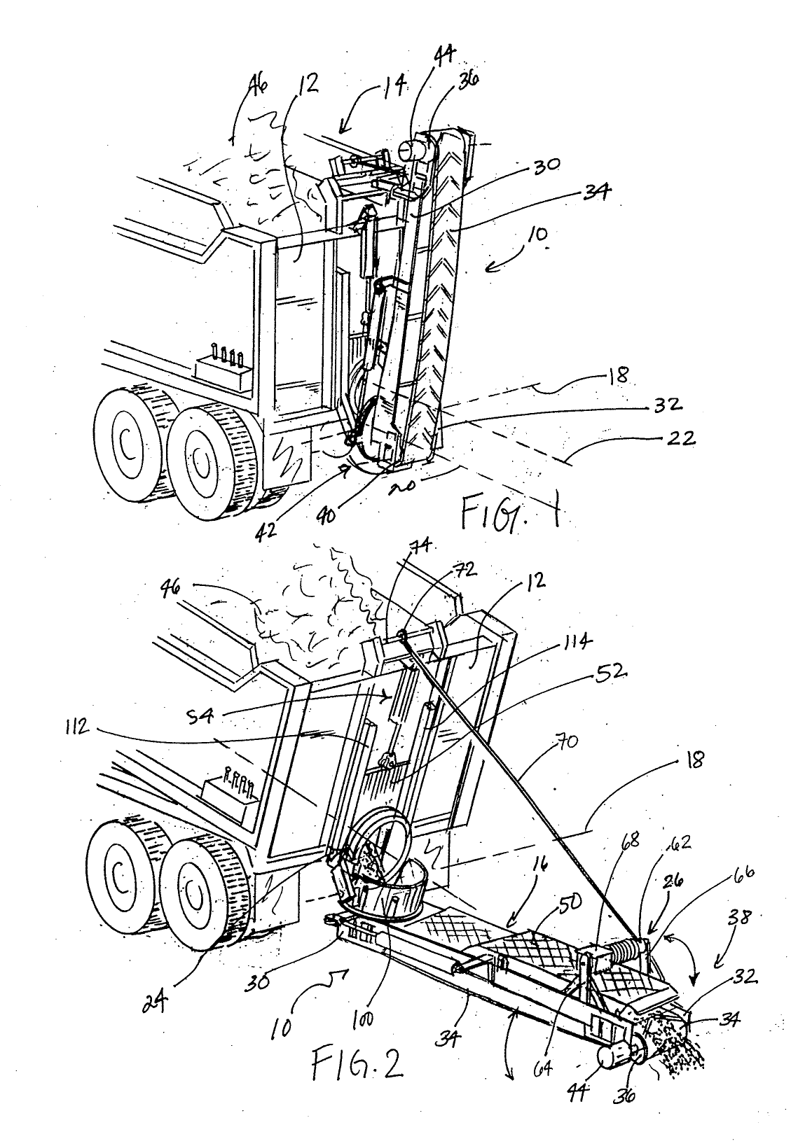

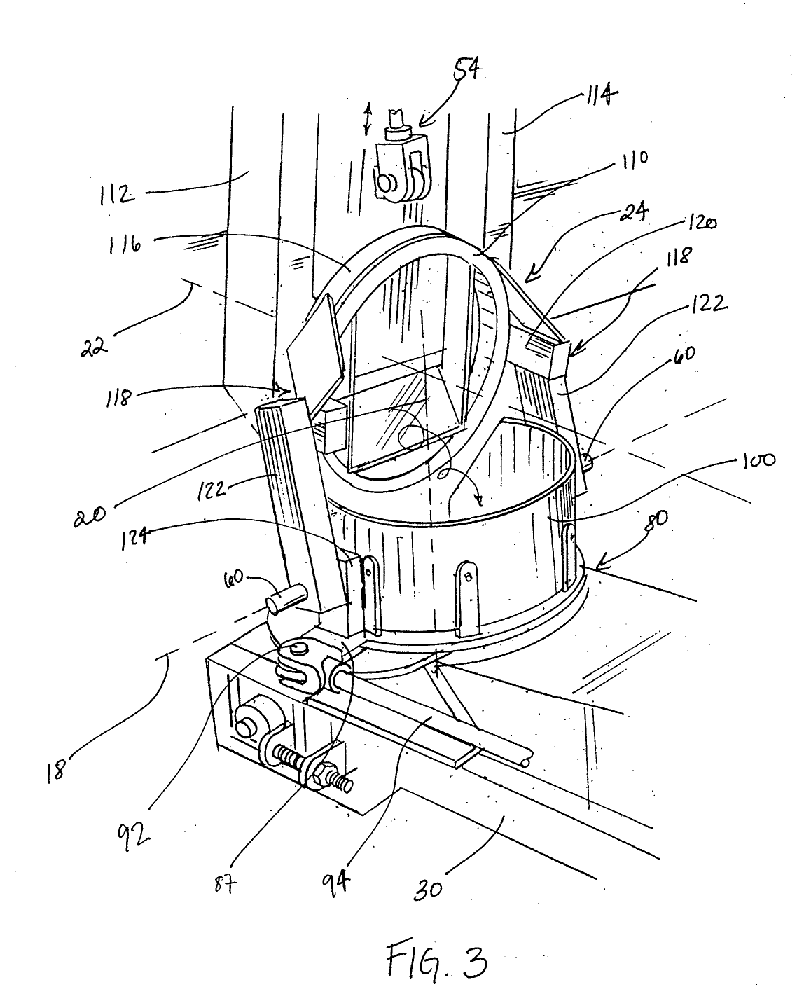

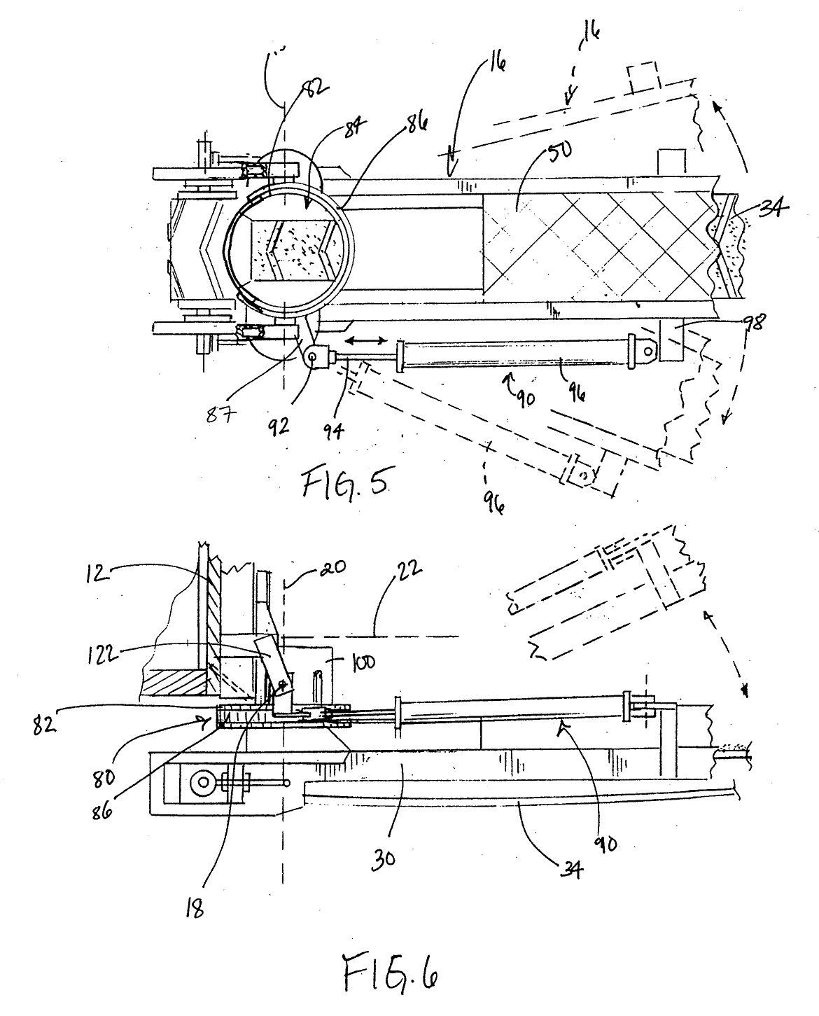

Referring now to FIGS. 1-6, an apparatus 10 is coupled to a tailgate 12 of a dump truck 14 for movement between a non-use, or stowed, orientation (FIG. 1) and a use orientation (FIG. 2). Although truck 14 is illustrated, it should be understood that the apparatus 10 may be coupled to any suitable vehicle. As is discussed in greater detail below, the apparatus 10 includes a conveyor 16 which is pivotable relative to the truck 14 about three axes. For example, the conveyor 16 is pivotable about a first axis 18 to raise and lower the conveyor 16 between the stowed and use orientations. The conveyor 16 is also pivotable about a second axis 20 to swing laterally from side to side. The conveyor 16 is also pivotable about a third axis 22 to aid in orienting the conveyor 16 level from side to side.

Turning now particularly to FIGS. 1 and 2, the apparatus 10 includes a joint 24 coupled to the tailgate 12 of the truck 14, the conveyor 16 which is movable relative to the truck 14, and a winch assembly 26 coupled to the conveyor 16 and the truck 14 to raise and lower the conveyor 16 between the stowed and use orientations. The illustrative conveyor 16 does not include multiple hinged sub-sections which articulate relative to each other to a folded orientation, for example, when the conveyor 16 is in the stowed orientation. Conveyor 16 includes two side beams 30, 32 and a conveyor belt 34 between the side beams 30, 32. A motorized roller, or drum pulley, 36 of the conveyor 16 is located at a distal end 38 of the conveyor 16 away from the truck 14 while a driven roller, or wing pulley, 40 is located at a proximal end 42 of the conveyor 16. A conveyor drive motor/transmission 44 drives the drum pulley 36. Illustratively, the conveyor drive motor/transmission 44 includes a hydraulic motor. However, other motor systems may be used as well, as discussed in greater detail below. The conveyor belt 34 is trained about the drum pulley 36 and the wing pulley 40 to convey the load from the truck 14 to the distal end 38 of conveyor 16 when the drum pulley 36 is driven by the motor/transmission 44. As gravel 46 or other contents of the truck 14 are unloaded onto the proximal end 42 of conveyor belt 34, the gravel 46 is carried by the conveyor belt 34 to the distal end 38 of the conveyor 16 and is ejected in a stream from the distal end 38 and deposited at a desired location within, for example, about 75-125 feet (about 23-38 m) or so in the direction that conveyor 16 is directed.

During operation, the conveyor 16 is cantilevered from the truck 14 when the conveyor 16 is in the use orientation. The distal end 38 of the conveyor 16 is unsupported from below when in the use orientation. Only the winch assembly 26, described in greater detail below, operates to support the distal end 38 of the conveyor 16 when the conveyor 16 is in the use orientation.

Illustratively, the conveyor 16 includes a cover 50 positioned above and spaced apart from the upper run of the conveyor belt 34. The cover 50 generally covers and shields the load 46 on the conveyor belt 34 to maintain the load 46 on the conveyor belt 34 as the load 46 travels from the proximal end 42 of the conveyor 16 to the distal end 38. Accordingly, the cover 50 prevents the load 46 from being ejected from the conveyor 16 before the load 46 reaches the distal end 38. Illustratively, the cover 50 is sheet metal, sheet plastic or other suitable material. The tailgate 12 of the truck 14 includes a slidable gate 52 which is opened and closed by, for example, a linear hydraulic piston-and-cylinder motor 54 mounted on the tailgate 12. The piston and cylinder of motor 54 are coupled between the tailgate 12 and the gate 52 to move the gate 52 between opened and closed orientations. When the gate 52 is open, the load 46 flows from the truck 14 through a chute 100 provided at the proximal end 42 of conveyor 16 and thence onto the conveyor belt 34. While the motor 54 is provided to open and close the gate 52, it is within the scope of this disclosure for opening and closing of the gate 52 to be powered by any other suitable type of motor, and for the gate 52 to be manually opened and closed as well.

Referring now particularly to FIG. 2, the winch assembly 26 of apparatus 10 is provided to raise and lower the distal end 38 of conveyor 16 between stowed and use orientations. Illustratively, as is discussed in greater detail below, the conveyor 16 of the apparatus 10 is pivoted about the first axis 18 (FIGS. 1-3) between stowed and use orientations. In particular, pivot pins 60 defining the pivot axis 18 couple the conveyor 16 to the truck 14, as is discussed in greater detail below. Illustratively, the winch assembly 26 is mounted at distal end 38 and includes a hydraulic motor/transmission 68 driving a winch spool or drum 62. Support arms 64, 66 of the winch assembly are removably coupled to respective side beams 30, 32 of the conveyor 16 and the hydraulic motor/transmission 68 and spool or drum 62 are supported by the support arms 64, 66. A cable 70 of any suitable construction is wound on the spool 62. A free end of cable 70 is provided with a hook 72 or other suitable anchoring device to be coupled to a suitable anchor 74 on the tailgate 12, for example.

In operation, hook 72 is secured to anchor 74 and the motor 68 is operated to rotate spool 62 in a first direction to unwind the cable 70 from the spool 62 and lower the conveyor 16 to a use orientation. Alternatively, the motor 68 may be operated to rotate spool 62 in a second direction to wind the cable 70 onto the spool 62 and raise the conveyor 16. A travel limit switch or the like (not shown) may be included to shut motor 68 off when conveyor 16 reaches its stowed orientation against the tailgate 14. Mounting the winch assembly 26 to the conveyor 16 of the apparatus 10 permits the apparatus 10 to be moved from vehicle to vehicle without the need for the vehicle itself to provide a raising and lowering mechanism for the conveyor 16. It is within the scope of this disclosure, however, to mount winch assembly 26 on the vehicle such that the anchor 72 of the winch's cable 70 may be removably coupled to conveyor 16. Further, while the winch assembly 26 is illustrated as mounted to the distal end 38 of the conveyor 16, the winch assembly 26 may be mounted at any point along the length of the conveyor 16.

Referring now more particularly to FIGS. 3-6, apparatus 10 further includes a turret assembly 80 at the proximal end 42 of the conveyor 16. Illustratively, the turret assembly 80 includes a turret ring 82 defining the second axis 20 about which the conveyor 16 pivots to provide lateral side to side traversal of the distal end 38 of the conveyor 16 to facilitate discharge of the load 46 at the desired location(s). Ring 82 includes a central opening 84 therethrough around which chute 100 is provided. A turret holder 86 is generally C-shaped and is received within a channel provided around the outside surface of the turret hub 82 so that the turret hub 82 is retained in turret holder 86 and is able to pivot about the second axis 20 relative to the turret holder 86. To promote relatively free movement of the turret hub 82 with respect to the turret holder 86, one or the other or both of turret hub 82 and turret holder 86 may be provided with grease fittings or the like (not shown) for the deposit of (a) suitable lubricant(s) between their adjacent bearing surfaces. As is discussed in greater detail below, the turret holder 86 is coupled through the joint 24 to the truck 14. A link 87 is coupled at a proximal end to the turret holder 86 and extends outwardly from the turret holder 86. A drive mechanism is coupled at a pivot point 92 to the distal end of the link 87. Illustratively, the drive mechanism includes a linear hydraulic piston-and-cylinder motor 90 coupled to the link 87 and to a flange 98 provided on, and extending outwardly from, the beam 30.

The motor 90 and link 87 mechanism is actuable through a hydraulic fluid circuit including a pump (not shown) for pivoting the conveyor 16 about the second axis 20. As is discussed in greater detail below, other drive mechanisms exist for traversing the distal end 38 of conveyor 16.

In use, the motor 90 may be activated to either extend or retract the piston 94 of motor 90 within the cylinder 96 of motor 90 to traverse the distal end 38 of conveyor from side to side about the second axis 20. Illustratively, chute 100 of the turret assembly 80 is coupled to the turret hub 82 to guide the load 46 being dumped from the truck 14 onto the conveyor belt 34.

Referring now particularly to FIG. 3, joint 24 of apparatus 10 includes a hub 110 mounted to the tailgate 12 of the truck 14 by two supports 112, 114. Illustratively, the hub 110 is attached between the two supports 112, 114 around the gate 52 through which the load 46 is to pass when the gate 52 is open. The hub 110 is generally ring-shaped with the center of the ring defining the third axis 22. A ring 116 of the joint 24 occupies an outwardly opening or facing channel around the hub 110 for movement about the third axis 22 relative to the hub 110. To promote relatively free movement of the ring 116 with respect to the hub 110, one or the other or both of hub 110 and ring 116 may be provided with grease fittings or the like (not shown) for the deposit of (a) suitable lubricant(s) between their adjacent bearing surfaces.

A bracket assembly 118 of joint 24 is coupled to generally diametrically opposite points on the ring 116 and to the proximal end 42 of the conveyor 16 such that the conveyor 16 is movable with the ring 116 about the third axis 22. In particular, each bracket assembly 118 includes first, second, and third bracket members 120, 122, 124. The first bracket member 120 of each assembly 118 is coupled to the ring 116 as well as to the second bracket member 122. The second bracket member 122 is coupled to both the first bracket member 120 and the third bracket member 124 of each assembly 118. The third bracket member 124 of each assembly 118 is coupled to the turret holder 86 of the turret assembly 80 and thus remains stationary as the conveyor 16 is traversed about the second axis 20. Further, the pivot pins 60 defining the first axis 18 about which the conveyor 16 pivots between stowed and use orientations pivotally couple the second and third bracket members 122, 124 of each of the bracket assemblies 118. In other words, the second bracket member 122 of each bracket assembly 118 is pivotably coupled to the respective third bracket member 124 by the pivot pins 60.

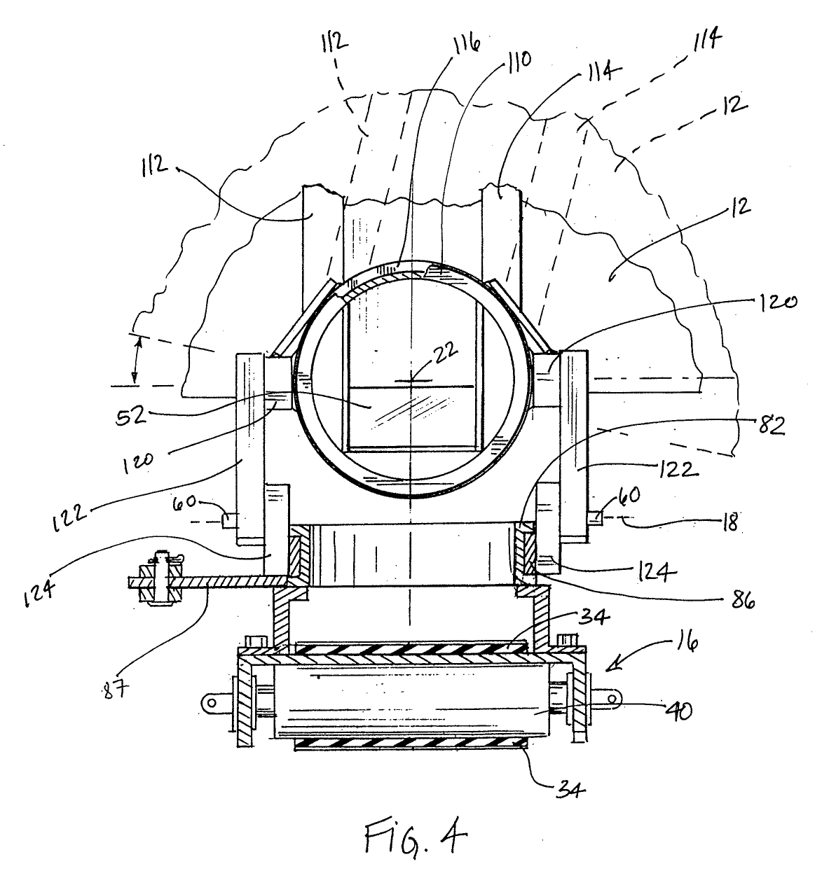

In use, the joint 24 is controlled by the weight of the conveyor 16 coupled thereto and the load 46 carried by the conveyor 16 to reduce side-to-side tilt of the conveyor 16. In other words, ring 116 of joint 24 is able to rotate relatively freely with respect to hub 110 about the third axis 22 permitting ring 116 to minimize tilt between a point along the length of beam 30 and a corresponding point the same distance along the length of beam 32. As illustrated in FIG. 4, for example, beams 30, 32 remain in the same orientation regardless of the level orientation or uneven orientation (shown in phantom) of the truck 14 to which apparatus 10 is mounted. Maintaining the conveyor 16 generally in such an orientation operates to maintain the load 46 being conveyed along the conveyor 16 distributed generally as it was placed when it was deposited from the truck 14 across the width of the conveyor 16 prior to reaching the distal end 38 of the conveyor 16.

In use, therefore, apparatus 10 defines three pivot axes about which the conveyor 16 of apparatus 10 pivots. The first axis 18, illustrated in FIGS. 2, 3 and 5, is defined through a pair of pivot pins 60 extending through the bracket assembly 118 coupling the turret assembly 80 to the joint 24. The winch assembly 26 pivots the conveyor 16 about the first axis 18 for movement of the conveyor 16 between stowed and use orientations. The second axis 20, illustrated in FIGS. 3, 4 and 6, is defined through the center of the turret hub 82 of the turret assembly 80. The second axis 20 is perpendicular to the first axis 18 and is perpendicular to a plane defined by the turret hub 82. The motor 90 rotates the conveyor 16 about the second axis 20 in order to traverse the distal end 38 of the conveyor 16 from side-to-side, as illustrated in FIG. 5. Finally, the third axis 22, illustrated in FIGS. 2, 3, 4 and 6, is defined through the center of joint 24 coupled to the tailgate 12 of the truck 14.

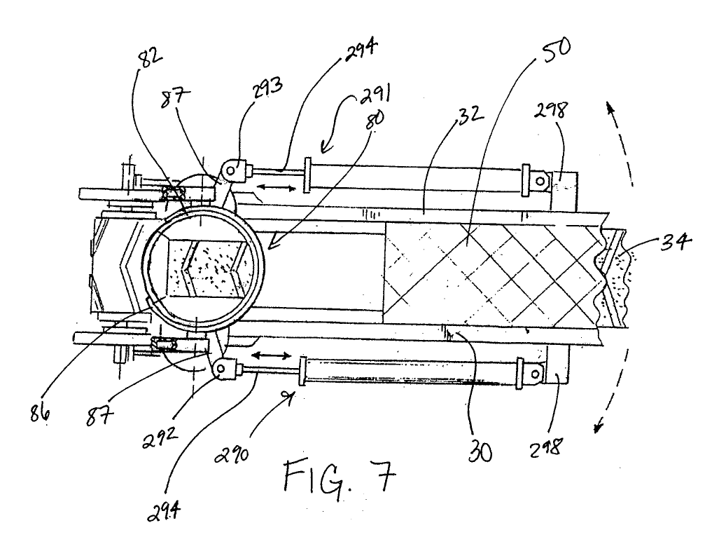

Turning now to FIGS. 7-10, additional lateral drive mechanisms for moving the conveyor 16 about the second axis 20 are provided. Referring first to FIG. 7, a drive mechanism 200 includes first and second linear hydraulic piston-and-cylinder motors 290, 291 as well as first and second links 292, 293 projecting from turret holder 86. Respective motors 290, 291 are pivotally coupled to respective links 292, 293. The other end of each motor 290, 291 is coupled to a respective one of the beams 30, 32 of the conveyor 16 by a mount 298. Such a two-motor drive mechanism may be used, for example, for heavier loads 46 and/or longer conveyors 16. In operation, as one of the motors 290, 291 is extended, the other motor 290, 291 is retracted in order to traverse the distal end 38 of conveyor 16.

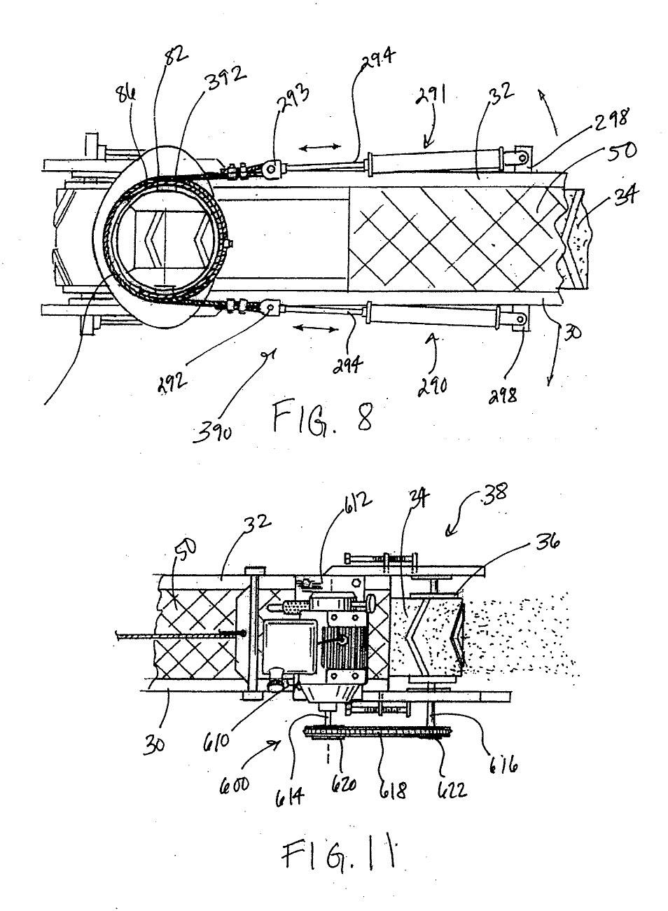

Referring now to FIG. 8, another drive mechanism 390 is provided. The drive mechanism 390 illustrated in FIG. 8 is similar to the drive mechanism 290 illustrated in FIG. 7. As such, like reference numbers have been used to denote like components. Illustratively, the drive mechanism 390 of FIG. 8 includes the two hydraulic cylinders 290, 291 and mounting brackets 298 as well as a cable 392 which is wrapped around the turret holder 86 of the turret assembly 80 and clamped to the turret holder 86 at about the midpoint of its length. Illustratively, the ends of cable 392 are coupled to respective motors 290, 291 while a middle portion of the cable 392 is wrapped around the turret holder 86 of the turret assembly 80. This two-cylinder drive mechanism 390 is operated in a similar manner as that discussed above with reference to the drive mechanism 90 illustrated in FIG. 7.

Referring now to FIG. 9, another drive mechanism 490 is illustrated. The drive mechanism 490 is similar to the drive mechanisms 200, 390 described above. As such, like reference numbers have been used to denote like components. Illustratively, the drive mechanism 490 of FIG. 9 includes two linear hydraulic piston-and-cylinder motors 290, 291, mounting brackets 298, and a length of roller chain 492 around a turret holder 486. Turret holder 486 includes sprocket teeth configured for engagement by the chain 492. Each end of the chain 492 is coupled to a respective hydraulic motor 290, 291. This two-motor drive mechanism 490 operates in a similar manner as that discussed above with reference to the drive mechanisms 200, 390 illustrated in FIGS. 7 and 8.

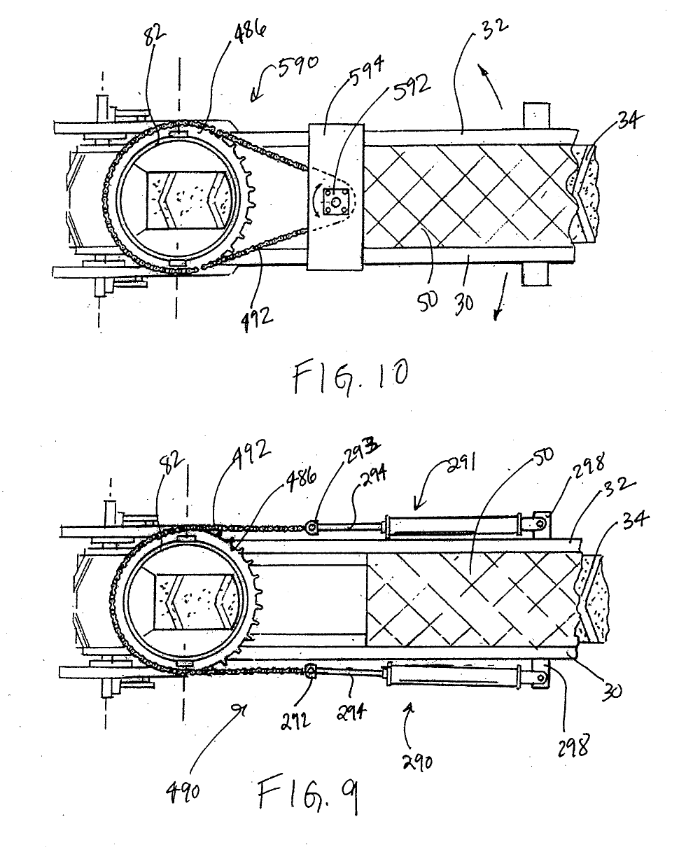

Referring now to FIG. 10, still another drive mechanism 590 is provided. The drive mechanism 590 is similar to the drive mechanism 490 describe with reference to FIG. 9 above. As such, like reference numbers have been used to denote like components. Illustratively, the drive mechanism 590 includes a reversible rotary motor/transmission 592 mounted to the beams 30, 32 of the conveyor 16 via a mounting bracket. The chain 492 of the drive mechanism 590 engages the sprocket-toothed turret holder 486 and another sprocket (not shown) coupled to an output shaft (not shown) of the motor/transmission 592. The motor/transmission 592 is run in one direction or the other to traverse the distal end 38 of conveyor 16.

Referring now to FIG. 11, the distal end 38 of the conveyor 16 illustrates another drive mechanism 600 for driving the drum pulley 36. As discussed above, the conveyor 16 illustrated in FIGS. 1 and 2 includes hydraulic motor/transmission 44 coupled to the drum pulley 36 in order to rotate the drum pulley 36 to move the conveyor belt 34. Alternatively, a gasoline or diesel engine/transmission 610, electric motor/transmission, or other suitable prime mover may be used to drive the drum pulley 36. As illustrated in FIG. 11, engine/transmission 610 is mounted via a mounting bracket 612 extending between the conveyor side beams 30, 32. An output shaft 614 of engine/transmission 610 is coupled by a sprocket 620 mounted on output shaft 614, a roller chain 618, and a sprocket 622 mounted on a shaft 616 of pulley 36 to pulley 36. The output of the engine/transmission 610 is transferred to the pulley 36 in order to move the conveyor belt 34.

As noted above, the illustrated conveyor 16 does not include hinged sub-sections pivotable relative to each other. Of course, while conveyor 16 is not configured to be folded along its length, it is within the scope of this disclosure to include a conveyor having two or more sections hingedly coupled to one another which are extended in the use orientation and which are folded in the stowed orientation.

What is claimed is:

1. Apparatus configured to be coupled to a vehicle, the apparatus comprising:
a conveyor including a conveyor belt,
a first joint coupled to the conveyor, the first joint defining a first axis about which the conveyor is configured to pivot between a stowed orientation and a use orientation,
a second joint coupled to the conveyor, the second joint defining a second axis about which the conveyor is configured to pivot from side to side, and
a third joint coupled to the conveyor and configured to be coupled to the vehicle, the third joint defining a third axis about which the conveyor is able to pivot.

2. The apparatus of claim 1, wherein the second joint includes a turret assembly having a turret hub coupled to the conveyor for pivoting movement about the first axis with the conveyor, a turret holder positioned around the turret hub and configured to be coupled to the vehicle, and a drive mechanism coupled to the conveyor and the turret holder.

3. The apparatus of claim 2, wherein the turret hub is generally cylindrical and the second axis extends through a center of the turret hub.

4. The apparatus of claim 2, wherein the drive mechanism includes a first hydraulic cylinder having a first end coupled to the conveyor and a second end pivotally coupled to the turret holder.

5. The apparatus of claim 4, wherein the drive mechanism includes a second hydraulic cylinder having a first end coupled to the conveyor and a second end pivotally coupled to the turret holder.

6. The apparatus of claim 2, wherein the drive mechanism includes first and second hydraulic cylinders and a cable having a first end coupled to the first hydraulic cylinder, a second end coupled to the second hydraulic cylinder, and a middle portion between the first and second ends extending around the turret holder.

7. The apparatus of claim 2, wherein the drive mechanism includes first and second hydraulic cylinders and a chain having a first end coupled to the first hydraulic cylinder, a second end coupled to the second hydraulic cylinder, and a middle portion between the first and second ends extending around the turret holder.

8. The apparatus of claim 7, wherein the turret holder includes a sprocket, the chain engaging the sprocket.

9. The apparatus of claim 2, wherein the drive mechanism includes a motor coupled to the conveyor and a chain coupled to the motor and the turret holder.

10. The apparatus of claim 9, wherein the turret holder includes a sprocket, the chain engaging the sprocket.

11. The apparatus of claim 1, wherein the third joint includes a hub configured to be coupled to the vehicle, a ring positioned around the hub for movement about the third axis relative to the hub, and a bracket assembly coupled to the ring and the conveyor.

12. The apparatus of claim 11, wherein the third axis is defined through the center of the hub.

13. The apparatus of claim 11, wherein a portion of the third joint is received within a portion of the second joint when the conveyor is in the stowed orientation.

14. The apparatus of claim 1, wherein the second axis and the third axis intersect each other when the conveyor is in a use orientation.

15. The apparatus of claim 1, wherein the first joint includes a hinge pin coupled to the second joint.

16. The apparatus of claim 1, further comprising a winch assembly coupled to a distal end of the conveyor.

17. The apparatus of claim 16, wherein the winch assembly includes a spool coupled to the conveyor, a motor coupled to the spool to rotate the spool in first and second directions, and a cable coupled to the spool and configured to be coupled to the vehicle.

18. The apparatus of claim 1, wherein the conveyor further includes a first pulley at a distal end of the conveyor and a second pulley at a proximal end of the conveyor, the conveyor belt being trained around the first and second pulleys.

19. The apparatus of claim 18, wherein the conveyor further includes a hydraulic motor coupled to the first pulley to rotate the first pulley.

20. The apparatus of claim 18, wherein the conveyor further includes an engine/transmission coupled to the first pulley to rotate the first pulley.

21. The apparatus of claim 1, wherein the conveyor defines a length between a proximal end of the conveyor and a distal end of the conveyor, and wherein the length of the conveyor remains relatively unchanged as the conveyor is moved between a use orientation and a non-use orientation.

22. Apparatus configured to be coupled to a vehicle, the apparatus comprising a conveyor configured to move between a non-use orientation generally adjacent the vehicle and a use orientation not generally adjacent the vehicle.

23. The apparatus of claim 22, further comprising a pivot joint coupled to the conveyor and configured to be coupled to the vehicle, the conveyor configured to pivot about an axis of the pivot joint.

24. The apparatus of claim 22, wherein the conveyor includes a proximal end configured to be coupled to the vehicle and a distal end extending away from the vehicle when the conveyor is in the use orientation.

25. The apparatus of claim 22, wherein the conveyor includes first and second spaced apart sides, and a conveyor belt forming a continuous loop between a proximal end of the conveyor and a distal end of the conveyor and between the first and second spaced apart sides.

26. The apparatus of claim 25, wherein the conveyor further includes a first pulley at the proximal end and a second pulley at the distal end, the conveyor belt trained around the first and second pulleys.

27. The apparatus of claim 22, wherein the conveyor defines a length between a proximal end of the conveyor and a distal end of the conveyor, and wherein the length of the conveyor remains relatively unchanged as the conveyor is moved between the use and non-use orientations.

28. Apparatus configured to be coupled to a vehicle, the apparatus comprising:
a conveyor movable between a use position and a non-use position, the conveyor including first and second unarticulated sides, a proximal end configured to be coupled to the vehicle and a distal end, a first pulley coupled to the distal end of the conveyor, a second pulley coupled to the proximal end of the conveyor, and a conveyor belt trained around the first and second pulleys,
a winch coupled to the distal end of the conveyor, the winch including a motorized spool,
a cable wound on the spool and configured to be coupled to the vehicle, and
a joint for coupling the proximal end of the conveyor to the vehicle, the joint defining an axis generally perpendicular to a surface of the vehicle from which the joint is mounted, the conveyor configured to pivot about the axis.
